(19) United States
(12) Patent Application Publication
(10) Pub. No.: US 2020/0267819 A1
(43) Pub. Date: Aug. 20, 2020

(54) LED LAMP AND METHOD FOR MANUFACTURING SAID LAMP

(71) Applicant: Raffaele STANO, Follonica, Grosseto (IT)

(72) Inventor: Raffaele STANO, Follonica, Grosseto (IT)

(21) Appl. No.: 16/761,545

(22) PCT Filed: Nov. 6, 2018
(86) PCT No.: PCT/IB2018/058694

§ 371 Date: May 5, 2020

(30) Foreign Application Priority Data
Nov. 6, 2017 (IT) 102017000125781

(51) Int. Cl. H05B 45/40; F21K 9/232

(52) U.S. Cl. CPC H05B 45/40; F21Y 2105/18; F21K 9/232

(57) ABSTRACT

A LED lamp comprising an attachment body comprising electrical contacts; an inner support for LED filaments fastened to said attachment body; at least one LED filament fastened to said inner support, electrical conductors connected between said electrical contacts and said at least one LED filament for electrically powering said at least one LED filament; in which said inner support for LED filaments comprises a sheet-shaped body fastened to said attachment body; said at least one LED filament being fastened to said sheet-shaped body so as to adhere directly to said sheet-shaped body.

### FIELD OF THE INVENTION

The present invention relates to a LED lamp.

### BACKGROUND ART

LED lamps adapted to replace known lamps with standard attachments, are increasingly common.

As shown for example in FIG. 1, a LED lamp 100 in particular is known, which is aesthetically very similar to a traditional lamp with a glass bulb, standard screw and tungsten filaments, in which the tungsten filaments are replaced by LED filaments 103.

The LED filaments 103 are arranged in the glass bulb 102 along longitudinal lines arranged about a glass support 107 that extends along a middle axis. The powering wires 106 pass through support 107 and reach screw 101, inside of which the powering electronics are arranged.

The glass support 107 forms an inner frame structure having a middle column 104, a lower end star 109 fastened to a base of the column and an opposite upper end star 105 fastened to a free upper end of the column, in which the opposite ends of the LED filaments 103 are fastened to free ends of radial elements of said lower end star 109 and of said upper end star 105, respectively.

Known LED filaments comprise a glass or sapphire bar, on which a given number of blue and red micro LEDs are arranged in series. This known art, called Chip-On-Glass (COG), allows the light emitted by the LEDs to be diffused uniformly and without interference over the whole structure, which is then coated with a light yellow/orange fluorescent resin that gives the light emitted the right coloring.

The glass or sapphire bar of the most common LED filaments has a thickness of about 0.5 mm, a width of about 1 mm and a length of about 30 mm.

The above-described known technology it is not without disadvantages.

It is difficult to build the structure of the inner glass frame because it requires assembling together the column and the two stars, arranging conductors along the radial elements of the two stars, overhangingly fastening LED filaments with the ends thereof welded at free ends of the radial elements of the two stars, electrically connecting LED filaments to the conductors arranged along the radial elements of the stars.

Such a decidedly complex construction requires particularly complex and costly industrial assembly plants, and also rather long production times for each individual piece.

These disadvantages are even more unfavorable when considering that the lamps are to be manufactured with a very high production frequency in order to reduce the unit cost, this need not being very compatible with the one of making such a complex lamp structure.

Among other things, the increased unit costs of such LED lamps often are so high that they are not balanced by the energy savings obtained by using them.

The need is therefore felt to make available a new LED lamp capable of at least partly obviating the aforesaid disadvantages of the known art.

### SUMMARY OF THE INVENTION

It is the object of the present invention to devise and make available a LED lamp which allows the aforesaid needs to be met while at least partly obviating the drawbacks indicated above with reference to the known art.

In particular, an object of the present invention is to make available a LED filament lamp which allows a simpler and more affordable, and also a quicker production thereof with respect to the known art.

It is another object of the present invention to provide a LED lamp which is more resistant to impacts and is more solid with respect to known LED filament lamps.

It is a further object of the present invention to provide a LED filament lamp which provides the lamp designer with an increased creative freedom with regards to shapes and arrangements of the LED filaments in order to make creative figures, and which simultaneously is simpler, quicker and more affordable to build.

It is another object of the present invention to provide a manufacturing method of a LED lamp which allows a LED lamp to be obtained which is quick, affordable to build and solid.

It is a further object of the present invention to provide a manufacturing method of a LED lamp which also provides the lamp designer with an increased creative freedom with regards to shapes and arrangements of the LED filaments in order to make creative figures.

These and further objects and advantages are achieved by a LED lamp, and also by a method for manufacturing a LED lamp according to the independent appended claims.

Further objects, solutions and advantages are in the embodiments hereinafter described and claimed in the dependent claims.

### BRIEF DESCRIPTION OF THE DRAWINGS

The invention is disclosed below with the description of certain embodiments thereof, made by way of a non-limiting example, with reference to the accompanying drawings in which:

FIG. 1 shows a view of an example of LED filament lamp according to known art as described above;

FIG. 2 shows a perspective view of a LED filament lamp according to the present invention;

FIG. 3 shows a side view of the lamp in FIG. 2, wherein the lamp bulb is depicted with a dotted line;

FIG. 4 diagrammatically shows a horizontal section by means of a cross section plan IV of a detail in FIG. 2, if the LED filaments are arranged on a single face of the support plate;

FIG. 5 diagrammatically shows a horizontal section by means of the cross section plan IV if the LED filaments are arranged on both faces of the support plate;

FIGS. 6, 7, and 8 show a front view of a horizontal section according to section plan VII, and a vertical view according to section plan VIII, respectively, of a portion of the lamp in FIG. 2 wherein the LED filaments are arranged on both faces of the support plate;

FIG. 9 shows an embodiment wherein the inner support is a helically bent tape portion.

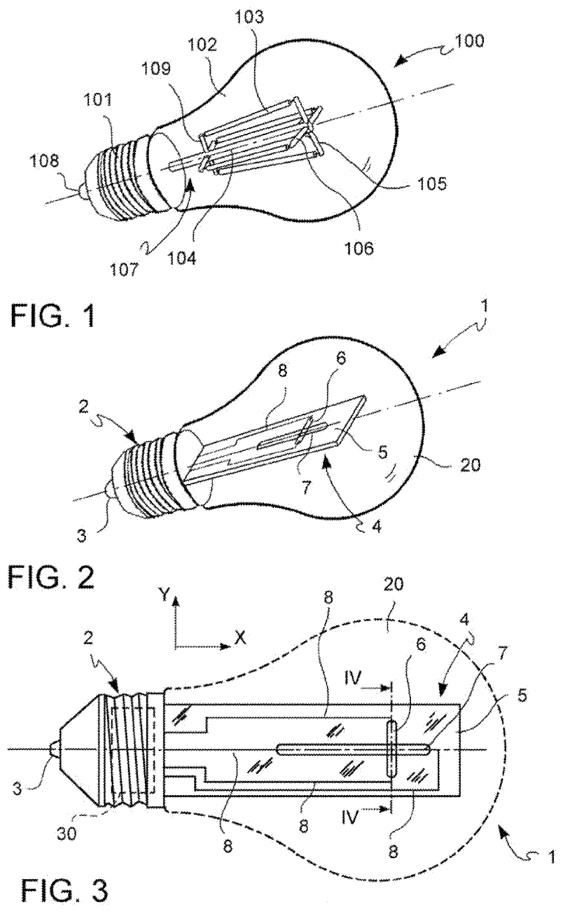

### DESCRIPTION OF THE PREFERRED EMBODIMENTS

With reference to FIGS. 2 to 8, a LED lamp according to the invention is indicated as a whole with numeral 1.

The LED lamp 1 comprises an attachment body 2 comprising electrical contacts 3.

According to an embodiment, the attachment body is a screw cap, for example of E27 type or of E14 type.

However, any other standard screw attachment body may be used.

Alternatively, the attachment body 3 may be of the bayonet type, or any other type of attachment body that can be coupled to a standard lampholder.

Lamp 1 comprises an inner support 4 for LED filaments fastened to said attachment body 2, at least one LED filament 6, 6′, 7, 7′ fastened to said inner support 4 and electrical conductors 8 connected between said electrical contacts 3 and said at least one LED filament 6, 6′, 7, 7′ for electrically powering said at least one LED filament 6, 6′, 7, 7′.

The inner support 4 for LED filaments comprises, or preferably is, a sheet-shaped body 5, or foil, fastened to said attachment body 2.

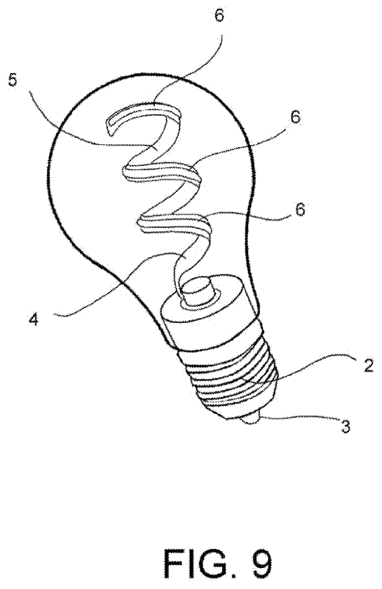

As shown in FIGS. 2, 3, 9, the inner support 4, the sheet-shaped body 5 in particular, is directly fastened to the attachment body 2, thus avoiding any additional connection element.

In other words, the sheet-shaped body 5 continuously extends from said attachment body 2, in particular without interruptions.

In other words, the sheet-shaped body 5 has a lower end of said sheet-shaped body 5 which is incorporated, inserted, blocked in the attachment body 2.

Thereby, it is avoided to mount the inner support 4, in particular the sheet-shaped body 5, in detached position with respect to the attachment body 2, thus avoiding the need to manufacture additional connection elements for connecting the inner support 4, in particular the sheet-shaped body 5, to the attachment body 2.

A result is a lamp with a clean and linear aesthetic design.

If the inner support 5, in particular the sheet-shaped body 5, is transparent, the LED filaments printed on the sheet-shaped body 5 appear to “flutter” in the lamp since no additional connection element for supporting the inner support 5, or the sheet-shaped body 4, is visible in position spaced apart from the attachment body 2.

Moreover, a result is a structurally solid and sturdy lamp because the inner support 4, the sheet-shaped body 5 in particular, is directly blocked in the attachment body 2.

Moreover, the at least one LED filament 6, 6′, 7, 7′ is fastened to the sheet-shaped body 5, or foil, so as to adhere directly thereto.

According to an embodiment, the at least one LED filament 6, 6′, 7, 7′ is directly built, or printed, or co-printed, on said sheet-shaped body 5, or foil.

In other words this means that, according to one embodiment, the at least one LED filament is directly assembled on one or both the faces of the sheet-shaped body 5, or foil, instead of being assembled elsewhere and then being fastened on the sheet-shaped body, or foil.

“Co-printed” means that the at least one LED may be formed together with the sheet-shaped body 5, or foil.

The at least one LED filament is rigidly fastened in adhering manner on the sheet-shaped body 5, or foil, thus forming a single body therewith.

According to an embodiment, the aforesaid electrical conductors 8 are printed, or co-printed, directly on said sheet-shaped body 5, or foil.

That is for example, the conductors 8 may be put down directly on the surface of the sheet-shaped body 5, or foil.

In other words, the conductors 8 are rigidly fastened, printed, on the surface of the sheet-shaped body, or foil, thus forming a single body.

Such conductors 8 may be printed along very thin lines, and therefore made invisible by the user.

The conductors 8 are formed by a layer of conducting material printed on the surface of said sheet-shaped body 5.

Such conductors, in particular such thin lines, or such a layer of conducting material, has transverse dimension less than 1 mm, preferably less than 0.5 mm, preferably ranging between 0.001 mm and 0.2 mm, even more preferably ranging between about 0.01 mm and 0.1 mm.

The provision of a sheet-shaped body 5 comprising both the at least one LED 6, 6′, 7, 7′ and also the conductors 8, all attached in adherent manner to the sheet-shaped body itself thus forming a single body, has various advantages, among which the easy maneuverability of the assembly of sheet-shaped body, LED filaments, conductors, during production, increased constructional sturdiness, increased resistance to mechanical stresses, increased product reliability.

Sheet-shaped body means a body extending mainly along two orthogonal directions X, Y for decidedly greater lengths than the thickness of the sheet-shaped body 5.

According to an embodiment, the sheet-shaped body 5 may be rigid or substantially rigid.

According to an embodiment, the sheet-shaped body 5, or foil, is transparent.

For example, the sheet-shaped body 5, or foil, is made with glass or sapphire, or it is made of glass or sapphire.

However, due to the reduced operating temperatures of the LED filaments, the sheet-shaped body could be made of polymeric material.

The transparency of the material of the sheet-shaped body 5 advantageously allows the at least one LED to be arranged according to fancy shapes or to highlight them as though they were suspended, separate from the lamp, fluttering.

This elevation, levitation effect of the light body that detaches from the lampholder makes lamp 1 particularly suitable for votive use by keeping it lit for votive offering in front of a sacred image.

The complete creative freedom allowed by the use of the transparent sheet-shaped body allows for example, religious figures to be made, e.g. a cross.

Among other things, the conductors co-printed, or printed, on the transparent sheet-shaped body may be so thin as to become invisible. In this case, only the LED filaments are visible.

According to an embodiment, the sheet-shaped body 5 is a plate, preferably a flat or substantially flat plate, preferably of rectangular shape.

The flat shape, which mainly extends along two directions, forms a base on which the at least one LED is arranged to form any shape.

According to an embodiment, the sheet-shaped body 5 comprises, or is, a helically bent tape portion, e.g. cylindrical or conical.

The sheet-shaped body 5 might also not be transparent, for example it may be a metal sheet, for example comprising aluminum or an aluminum alloy. Such a sheet may therefore be used to form three-dimensional shapes.

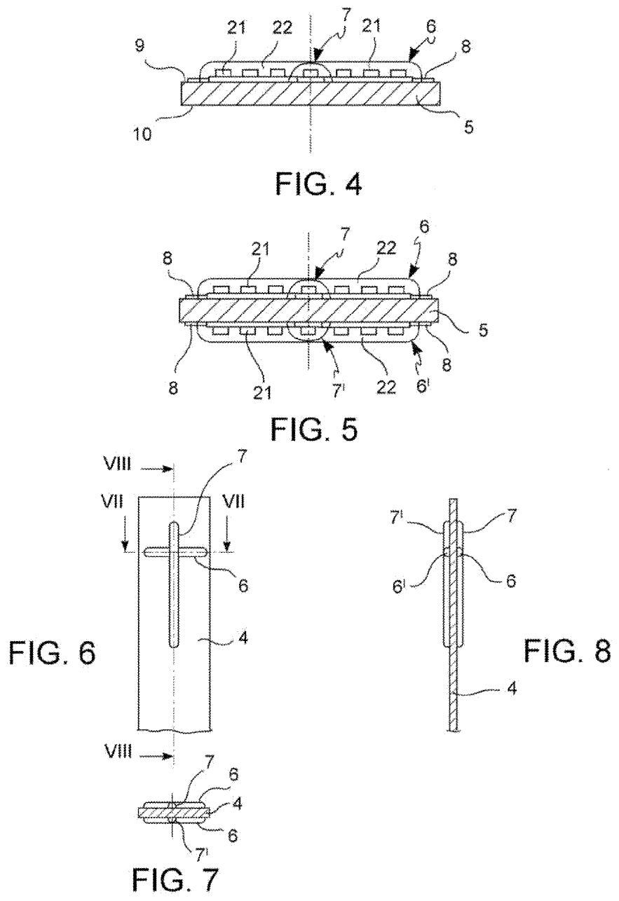

According to an embodiment as shown for example in FIG. 4, the at least one LED filament 6, 7 may be arranged on one face 9 alone of the sheet-shaped body 5.

According to an embodiment, the sheet-shaped body 5 defines two opposite sheet faces 9, 10, and the at least one LED filament 6, 6′, 7, 7′ is a plurality of LED filaments 6, 6′, 7, 7′, wherein the LED filaments 6, 6′, 7, 7′ are distributed over both faces 9, 10 of the sheet-shaped body 5, or of the plate, according to shapes and arrangements corresponding to each other.

In other words, both faces of the sheet-shaped body 5, or of the support plate, may be used as a base for the arrangement of LED filaments.

If the sheet-shaped body, or the support plate, is transparent, the image created by the LED filaments on one face is duplicated on the opposite face by arranging the LED filaments in corresponding manner to each other on both faces.

Thereby, the advantage is obtained of doubling the light power of the lamp with respect to the arrangement on one face alone.

Moreover, the light is emitted at about 360°.

Moreover, lamp 1 becomes increasingly reliable thereby because, in the case the LED filaments on one face should burn out, the ones arranged on the opposite face would continue to be lit without affecting the shape of the figure formed by the LED filaments.

According to an embodiment, the at least one LED filament 6, 6′, 7, 7′ is arranged so as to form a cross, for example a Christian cross.

Alternatively, the at least one LED filament may be arranged according to different shapes, for example to form the letters of the alphabet, or arrows.

According to an embodiment, the at least one LED filament 6, 6′, 7, 7′ is of the Chip-On-Glass, or COG, type, as shown in FIGS. 4 and 5.

In this case, the at least one LED filament 6, 6′, 7, 7′ comprises a plurality of micro LEDs 21 arranged in a row along a line and coated by a fluorescent resin 22, for example light yellow/orange in color, so as to give to the light emitted the right coloring.

According to an embodiment, the at least one LED filament may extend over at least one face of the sheet-shaped body 5, along two orthogonal directions, thereby forming a flat, two-dimensional figure, e.g. a heart or a star, e.g. a geometrical or irregular solid figure.

According to an embodiment, lamp 1 comprises an electronic unit 30 electrically connected with the electrical contacts 3 and with the conductors 8 so as to electrically power the at least one LED filament.

Such an electronic unit 30 preferably is interposed between the electrical contacts 3 and the conductors 8.

According to a preferred embodiment, the electronic unit 30 is located in the attachment body 2.

According to another aspect of the present invention, the aforesaid objects and advantages are achieved by a manufacturing method for manufacturing a LED lamp 1, in particular for manufacturing a LED filament lamp according to any of the features described above.

The aforesaid manufacturing method comprises the steps of providing an attachment body 2 comprising electrical contacts 3, providing an inner support for LED filaments 4 fastened to said attachment body 2, said inner support 4 comprising a sheet-shaped body 5, or foil, at least one LED filament 6, 6′, 7, 7′, electrical conductors 8 connected with said electrical contacts 3 and arranged to be electrically connected to said at least one LED filament 6, 6′, 7, 7′.

The method also comprises a step of fastening said at least one LED filament 6, 6′, 7, 7′ to said sheet-shaped body 5, or foil, so as to adhere directly to said sheet-shaped body 5, or foil.

According to an embodiment, the sheet-shaped body 5 extends mainly along two orthogonal directions X, Y.

According to an embodiment, the step of fastening the at least one LED filament 6, 6′, 7, 7′ to the sheet-shaped body 5 comprises a step of building, or assembling, said LED filament 6, 6′, 7, 7′ directly on said support plate 5, or of printing or co-printing said at least one LED filament 6, 6′, 7, 7′ on said sheet-shaped body, or on said plate 5.

According to an embodiment, the electrical conductors 8 are co-printed directly on said sheet-shaped body 5 or on said plate.

A skilled person in the art may make several changes and adaptations to the above-described embodiments of the device and of the method, and substitute elements with other functionally-equivalent ones in order to meet contingent needs, without departing from the scope of the following claims. Each of the features described as belonging to a possible embodiment may be achieved irrespective of the other embodiments described.

The expressions and terminology used purely serve a descriptive purpose and are therefore non-limiting.

Moreover, the drawings are not necessarily to scale.

All the features herein described and/or any step of the method herein described may be combined according to any combination, except the combinations in which at least some of such features and/or steps mutually exclude each other.

1. LED lamp comprising:
an attachment body comprising electrical contacts;
an inner support for LED filaments fastened to said attachment body;
at least one LED filament fastened to said inner support,
electrical conductors connected between said electrical contacts and said at least one LED filament for electrically powering said at least one LED filament;
wherein
said inner support for LED filaments comprises a sheet-shaped body;
said at least one LED filament is fastened to said sheet-shaped body so as to adhere directly to said sheet-shaped body.

2. Lamp according to claim 1, wherein the at least one LED filament is directly built or directly printed on said sheet-shaped body.

3. Lamp according to claim 1, wherein said electrical conductors are directly printed on said sheet-shaped body.

4. Lamp according to claim 1, wherein the sheet-shaped body is a flat plate of rectangular shape.

5. Lamp according to claim 1, wherein the sheet-shaped body comprises, or is, a helically bent tape portion.

6. Lamp according to claim 1, wherein the sheet-shaped body is transparent, or substantially transparent.

7. Lamp according to claim 6, wherein the sheet-shaped body defines two opposite sheet faces, and the at least one LED filament is a plurality of LED filaments, wherein the LED filaments are distributed on both sheet faces according to shapes and arrangements corresponding to each other.

8. Lamp according to claim 1, wherein the at least one LED filament is arranged so as to form a cross.

9. Manufacturing method for manufacturing a LED lamp comprising the steps of:
providing an attachment body comprising electrical contacts;
providing an inner support for LED filaments fastened to said attachment body, said inner support
comprising a sheet-shaped body;
at least one LED filament;
electrical conductors connected to said electrical contacts and arranged to be electrically connected to said at least one LED filament;
fastening said at least one LED filament to said sheet-shaped body so as to adhere directly to said sheet-shaped body.

10. Method according to claim 9, wherein the step of fastening the at least one LED filament to said sheet-shaped body comprises a step of building, or printing said at least one LED filament directly on said sheet-shaped body.
